(19) United States
(12) Patent Application Publication
(10) Pub. No.: US 2020/0118134 A1
(43) Pub. Date: Apr. 16, 2020

(54) CHECKING OF VALIDITY OF A REMOTE PAYMENT INTERFACE

(71) Applicant: ORANGE, Paris (FR)

(72) Inventors: Eric Beaufils, Chatillon Cedex (FR); Emmanuel Le Huerou, Chatillon Cedex (FR); Francois Toutain, Chatillon Cedex (FR)

(21) Appl. No.: 16/626,466

(22) PCT Filed: Jun. 6, 2018
(86) PCT No.: PCT/FR2018/000157

§ 371 Date: Dec. 24, 2019

(30) Foreign Application Priority Data
Jun. 26, 2017 (FR) 1755832

(51) Int. Cl. G06Q 20/40; G06Q 20/10; G10L 13/04; G06F 3/16

(52) U.S. Cl. CPC G06Q 20/4016; G06Q 20/102; H04L 63/083; G06F 3/167; G10L 13/043

(57) ABSTRACT

A method of checking validity of a remote payment interface on a terminal. This method is such that, during a payment transaction between a user and a remote payment site, it includes: receiving at least one historical datum in respect of the transaction between the user and the payment site; dispatching a code for validating the transaction as a function of the at least one historical datum. Correlatively, provided are: a method for dispatching data for validating a payment site; a checking device; and a payment server implementing these respective methods.

### CROSS-REFERENCE TO RELATED APPLICATIONS

This Application is a Section 371 National Stage Application of International Application No. PCT/FR2018/000157, filed Jun. 6, 2018, the content of which is incorporated herein by reference in its entirety, and published as WO 2019/002703 on Jan. 3, 2019, not in English.

### FIELD OF THE DISCLOSURE

The present invention relates to the field of online payment and of the online payment interfaces in a transaction between a user and a secure payment server.

In particular, the interest will be focused on mobile purchase, payment, conversational commerce applications via instant messaging interfaces for example, or, more conventionally, via a connection to merchant websites.

### BACKGROUND OF THE DISCLOSURE

In a request purchaser product or service between a merchant site and a user of a terminal, the merchant site uses a payment site to validate the transaction and recover the payment.

For that, the payment site asks the user to be authenticated before validating payment. This involves, for the payment site, verifying that the user is indeed the owner of the bankcard or of the payment account.

When the user is being registered on the payment site (for example when creating a “Orange cash” account or a “PayPal” account), the identity of the user is verified and associated with a password or a code of PIN (“Personal Identification Number”) code type that the user must create on that occasion.

During a payment, the user is redirected to an interface of the payment site and must prove his or her identity by inputting the password or the code.

If the payment site is capable of ensuring the authentication of the user of the transaction, the same does not apply for the user who does not have any effective means for ensuring the validity of a payment interface which is proposed to him or her.

Indeed, before entering his or her PIN code or else his or her password, it can be useful to ensure that this information does not fall into the hands of malevolent forgers.

Currently, one way of verifying that the payment interface is valid, when this interface is opened on a browser, is to verify that the protocol used is indeed the secure “https” certifying the validity of the name of the domain on which the payment interface is hosted. This domain name information is displayed on the interface and is associated with an illustration in the form of a closed padlock on the navigation interface.

However, there are various ways of tricking the user of such an interface. This padlock illustration is not very visible and the user does not necessarily note that it is not present.

In the case where the user is directed to a false payment site, the forger can provide, on his or her forged interface, the illustration of same padlock and thus trick the user who cannot necessarily recognize a valid domain name from another forged one, above all if they are deliberately similar.

In the case of a mobile payment interface, the size of the screen being limited, there is not always provision to display this domain name and this domain name certification.

Furthermore, in the case of transactions initiated by conversational commerce services, via instant messaging interfaces, for example, these web certifications are not provided on the payment interface proposed to the user. The latter therefore does not have a means of verifying the validity of the payment interface.

There is therefore a need, for the user of a payment interface, during a transaction, to verify the validity of the payment interface before validating the payment by entering her personal authentication data.

### SUMMARY

The present invention improves the situation.

To this end, it proposes a method for checking the validity of a remote payment interface on a terminal. The method is such that, during a payment transaction between a user and a remote payment site, it comprises the following steps:
reception of at least one historical datum of a transaction between the user and the payment site;
sending of a transaction validation code as a function of the at least one historical datum.

Thus, the historical transaction data of the user with the payment site allows the user or the terminal of the user to ensure that the payment site is indeed a payment site that the user has already used for past transactions. This payment site is not therefore fraudulent and the user can then insert his or her payment validation code in complete confidence.

The particular embodiments mentioned hereinbelow can be added independently or in combination with one another, to the steps of the checking method that are defined hereinabove.

In a particular embodiment, the at least one historical datum received is displayed on a payment interface comprising a validation code request.

Thus, just before entering his or her payment validation code, the user can verify that the historical information is valid. The display on one and the same interface of the code request and of the historical data ensures the user that it is indeed the same server which is sending these two items of information. The historical data displayed does indeed correspond to the payment site which is requesting the validation code.

Likewise, so as to alert the user to the importance of the data displayed, the display of the at least one historical datum is associated with the display of information cautioning the user if the at least one historical datum is not valid.

In a particular embodiment, the at least one historical datum is rendered vocally to the user via a voice interface of the terminal.

In one possible embodiment, the at least one historical datum comprises data on the date and amount of the last transaction or of several latest transactions or even a delivery address of the user.

These data make it possible to simple identify the past transactions or the link that the payment site has already had with the user.

Clearly, any other information on past transactions can be retrieved and obtained by the terminal to verify the validity thereof before the validation of the payment.

In a particular embodiment, the method comprises a step of comparison of transaction data stored in the terminal and a display of a message of validation of a valid historical datum verification on a payment interface.

This step is then performed automatically by the terminal which contains in memory the data on past transactions with one or more payment sites. The terminal receiving the historical data can then compare, as a function of the payment site, to see if the information received is indeed that stored and can then display a message to the user confirming the validity of the information received, in order for the latter to be able to enter the payment validation code in complete confidence.

In another embodiment, a step of verification that the at least one historical datum is valid is performed by the user by viewing displayed historical data or by listening to rendered historical data, before a step of interaction with the payment interface to enter the transaction validation data.

The user must then recall latest transactions that he or she has carried out with the payment site. If he or she does not recognize the historical datum or data displayed, then he or she does not enter the payment validation code and the transaction fails.

Correlatively, the invention also targets a method for sending validation data for a payment site to a terminal. The method is such that, during a payment transaction between the user of the terminal and the payment site, it comprises the following steps:
obtaining historical data on transactions between the user and the payment site;
sending at least one historical datum obtained to the terminal;
awaiting reception of a transaction validation code from the user of the terminal before validating the payment, the reception of the validation code being a function of the at least one historical datum sent.

The payment server thus retrieves the historical transaction data that have already passed between it and the user who wants to validate the payment. Through the sending of this information to the terminal of the user, it allows the latter to verify that this site is not a fraudulent site. The transaction will thus be able to be finalized by the reception of the validation code from the user.

In a particular embodiment, the at least one historical datum is sent with a payment interface comprising a transaction validation code request.

The simultaneous sending of the code request interface and of the historical data makes it possible to assure the user that it is indeed the same server which is sending these two items of information. The historical data sent to the terminal of the user therefore do indeed correspond to the payment site which is requesting the validation code. On reception of these two items of information, the user will be able to verify the validity of the historical data and will then be able to enter the payment validation code.

The invention targets a device for checking the validity of a remote payment interface. This device comprises a processing circuit comprising a processor and being capable of controlling:
a module for displaying a payment transaction interface during a payment transaction between a user and a remote payment site;
a communication module capable of receiving at least one historical datum of a transaction between the user and the payment site and of sending a transaction validation code via an interaction with the payment interface, as a function of the at least one historical datum.

The invention relates also to a communication terminal comprising a device as described.

The device and the terminal thus described comprise the same advantages as the checking method described that they implement.

Correlatively, the invention targets a server of a payment site. This server comprises a processing circuit comprising a processor and being capable of checking, during a payment transaction between the user and the payment site:
a memory comprising historical data of transactions between the user and the payment site and a module for obtaining at least one of these data;
   a communication module capable of sending to the terminal at least one historical datum obtained and of receiving a transaction validation code from the user of the terminal, the reception of the validation code being a function of the at least one historical datum sent;
   a module for validating the payment after verification of the validation code.

The server thus described comprises the same advantages as the method for sending validation data described that it implements.

The invention targets a computer program comprising code instructions for implementing the steps of the method for checking the validity of a remote payment interface as described previously and a computer program comprising code instructions for implementing the steps of the method for sending validation data for a payment site as described, when these instructions are executed by a processor.

Finally, the invention relates to a storage medium, that can be read by a processor, storing a computer program implementing a method for checking the validity of a remote payment interface as described previously, and a computer program implementing a method for sending payment site validation data as described previously.

The storage medium can be any entity or device capable of storing the program. For example, the medium can comprise a storage means, such as a ROM, a CD ROM or a microelectronic circuit ROM, or even a magnetic storage means, for example a hard disk. Also, the storage means can be a transmissible medium such as an electrical or optical signal, which can be routed via an electrical or optical cable, by radio or by other means. The program according to the invention can in particular be downloaded over a network of Internet type. Alternatively, the storage medium can be an integrated circuit in which the program is incorporated, the circuit being adapted to execute or to be used in the execution of the method concerned.

### BRIEF DESCRIPTION OF THE DRAWINGS

Other features and advantages of the invention will become more clearly apparent on reading the following description, given purely as a nonlimiting example, and with reference to the attached drawings, in which:

FIG. 1 illustrates a system notably comprising a terminal and a payment server implementing the invention in one embodiment;

FIG. 2 illustrates, in flow diagram form, the main steps of an embodiment of a method for checking the validity of a payment interface implemented by the terminal and of a method for sending validation data implemented by a payment server;

FIGS. 3a, 3b and 3c illustrate payment interfaces displayed on a terminal in particular embodiments of the invention;

FIG. 4 schematically illustrates a hardware representation of a terminal comprising a validity checking device and implementing a validity checking method according to an embodiment of the invention; and

FIG. 5 illustrates a hardware representation of a payment server implementing a method for sending validation data according to an embodiment of the invention.

### DETAILED DESCRIPTION OF ILLUSTRATIVE EMBODIMENTS

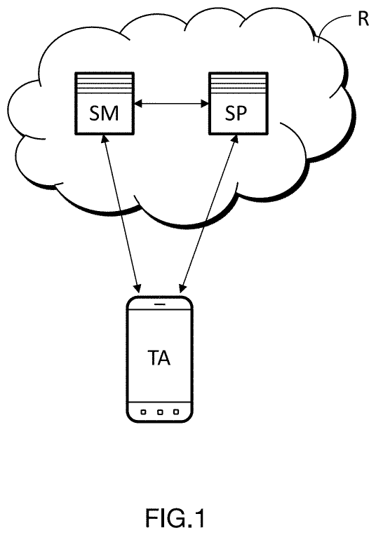

Reference is made first of all to FIG. 1 in which a communication terminal TA is represented. The terminal TA, here represented by a mobile terminal, comprises a communication interface for communicating to the network R where two servers are represented, a merchant server SM hosting a merchant site offering the purchasing of products or services and a payment server capable of receiving payment orders for the products or services requested and of validating these payments with the banks concerned or, more generally, with a payment account, the payment account being able to be hosted by a payment third party not necessarily banking services.

In a particular embodiment, the merchant server and the payment server can be combined.

The network R is a communication network, for example of IMS type, which makes it possible to set up communications between terminals and servers as represented here. The terminal TA can communicate to the servers SM or SP via a conversational commerce service based on an enriched instant messaging application, installed on the terminal and which makes it possible to interact with a robot adapted to the merchant site, for example, to order goods or services. The users of such enriched instant messaging applications do not then need to download applications dedicated to each merchant site or to access their website to enter an order.

Action buttons or hypertext links can also be provided on the conversational commerce interface to trigger a purchase action or else a web page viewing action.

The invention is not limited to the framework of IMS networks. The communication network R can be a GSM (Global System for Mobile communication) telecommunication network allowing voice communications to be set up and text messages to be exchanged by SMS (Short Message Service) for example. The network R is for example also the Internet network to which the terminal TA can connect to exchange data and access, among other things, the web pages of the merchants and place its orders.

The network R can also correspond to several distinct and interconnected networks from which the servers SM and SP are accessible. For example, the terminal TA can set up voice communications via a switched fixed network or a cellular network and text communications or data exchanges via a WiFi, 2G, 3G or 4G access network.

The terminal TA is, here, a cellphone of “smartphone” type having communication means suitable for connecting to one or more communication networks, such as Wifi networks or cellular networks, and a memory and a processor suitable for executing computer program instructions. The invention described hereinbelow can however be implemented on other terminals, such as on a tablet, a connected object, a vehicle dashboard or even a personal computer. The terminal TA is for example adapted to communicate according to at least one instant messaging protocol with other terminals or devices. For example, the terminal TA can transmit and receive messages of SMS (Short Message Service) type via a cellular network, or even implement the RCS (Rich Communication Suite) standard, the SIP SIMPLE protocol, Jabber or any other protocol suitable for sending and receiving messages. In particular, the terminal TA can exchange instant messages with the server SM through the network R.

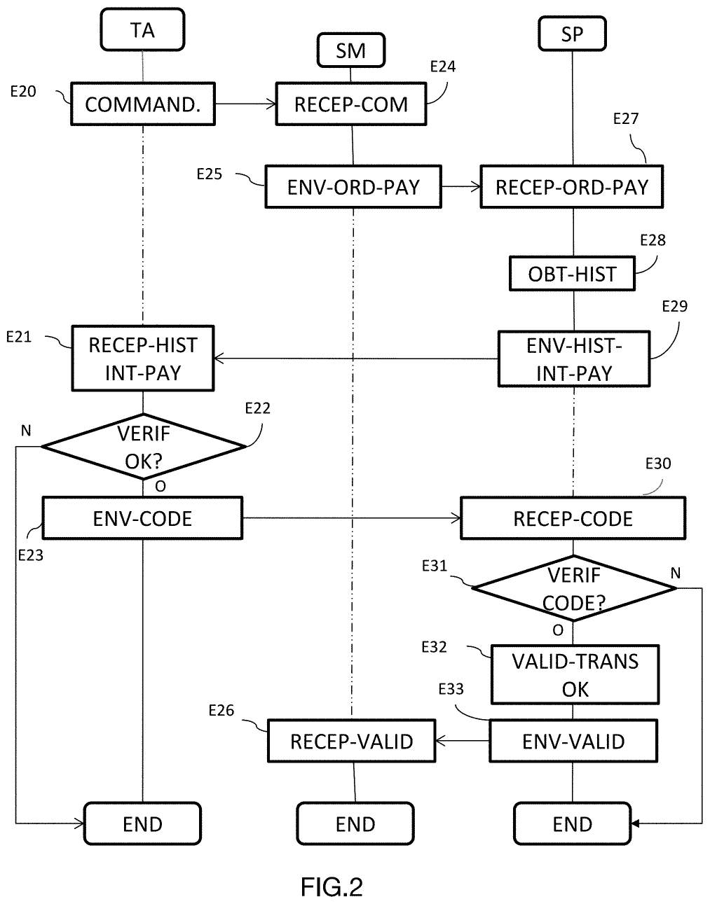

FIG. 2 represents the steps (E20 to E23) of a method for checking the validity of a payment interface implemented in the terminal TA, in one embodiment, and the steps (E27 to E33) of a method for sending validation data for a payment site implemented, for example, in a payment server SP.

FIG. 2 also represents the steps implemented on a merchant server SM offering products or services to the user of the terminal TA. This merchant server can also be a conversational agent (or robot) making it possible to offer the user goods or services from different merchants via instant messaging.

In one possible embodiment, the merchant server and the payment server can be one and the same server.

In the step E20, the user of the terminal TA, after viewing a website of the merchant site or else after an exchange of a conversation by instant messaging offering the purchase of a service or product, decides to validate an order by validating the creation of a shopping basket for example.

At E20, he or she places an order, that he or she transmits to the server SM for it to validate it and triggers the sending of a payment command. The server of the merchant site, SM, receives this order at E24 and transmits the payment command to a payment server SP for the latter to interact with the user of the terminal TA to validate the payment.

The payment server receives this payment command at E27.

In a variant embodiment of these exchange steps, for example for a conversational commerce application installed on the terminal TA, upon the validation of an order by the user of the terminal, the latter can receive, from the conversational agent of the server SM, a link or action button which allows it to pay and connects it directly with the payment server. This action button, when the user of the terminal actuates it, implements an application making it possible to exchange the identifiers both of the user of the terminal TA and of the merchant site, as well as the information on the transaction requested for the current order.

The payment server, SP, receiving this payment command at E27, looks up an internal or external data in which is stored information on the latest transactions performed in correlation with an identifier of the transmitter of the order.

In the step E28, the payment server therefore consults in its database and obtains the past transaction data corresponding to the identifier of the user who has transmitted the order for this payment command.

It sends at least one of these historical data to the terminal TA (step E29).

These historical data are, for example, the date and the amount of the last or else of the last two or three payments that the user has performed on this payment site. The name of the corresponding merchant site may also be seen therein.

Another datum may be the delivery address used for the latest purchases and transactions performed by this user.

Any information linked to the user and to the latest transactions can thus be found and sent to the terminal for validation.

These historical data are multimedia data, they can be in the form of text, of image or of sound and always relative to the user.

Obviously, the historical transaction data thus described exist only if the user has already performed a payment via this payment site.

In the case where no past transaction has been performed with the payment server, a personal datum of the user can then be sent as historical datum. This historical data was for example stored on the server when the user created his or her account with the payment server. It can be a response to a personal question or else personal information concerning his or her identity.

At E21, the terminal TA receives these historical data of the past transactions with the payment site.

These historical data are, in one embodiment, displayed on the payment interface and on the screen of the terminal.

In another embodiment, they are rendered vocally to the user via a voice interface of the terminal.

They can be displayed or rendered simultaneously with a request for entry of a payment validation code on the payment interface.

Thus, just before his or her payment validation code, the user can verify that the historical information is valid. The display on one and the same interface of the code request and of the historical data assures the user that it is indeed the same server which is sending these two items of information. The historical data displayed do indeed correspond to the payment site which is requesting the validation code.

In a particular embodiment, and so as to alert the user of the importance of the data displayed, the display of the historical data is associated with the display of cautioning information for the user if these historical data are not valid.

A step E22 of verification of the validity of these data is performed. This step is, in one possible embodiment, performed by the user himself/herself, by the viewing on the payment interface of the displayed historical transaction data or by listening to the rendered historical data. The user is then assured that the payment site is indeed a payment site that the user has already used for past transactions. This payment site is not therefore fraudulent and the user can then enter his or her payment validation code in complete confidence by interacting with the payment interface to enter his or her transaction validation data.

In another embodiment, the user can ask the payment server for other historical information in response to this first sending, in the case where he or she is not sure of being able to validate these first data.

The interface can thus provide an action button triggering the request for another datum from the server.

The payment server thus retrieves at least one other historical datum which concerns the user and performs a second sending of these data to the user.

A limited number of successive requests can be provided. Beyond this number, the transaction is automatically canceled.

When the validation data have been entered, they are sent to the payment server SP in the step E23.

In another embodiment, the step E22 of verification that the historical data are valid comprises a step of comparison of transaction data stored in the terminal and a display of a verification validation message on the payment interface.

These steps are performed then by the terminal itself which has stored in memory the latest transaction data and which can thus compare them with the historical data received. For that, the terminal implements this step via, for example, its internal operating system or else, in a particular embodiment and in the case of the implementation of conversational commerce, via the instant messaging software platform.

This comparison is performed before the display of the validation code request on the payment interface. This display is then accompanied by a message confirming that the terminal has indeed verified the historical data that it has received. The user can then, in complete confidence, enter his or her validation code.

In the case where the historical data are considered to be not valid, then the transaction fails, the user not entering his or her validation code.

When the payment server receives the validation code at E30, it verifies, at E31, that this validation code does indeed correspond to the authentication data of the user for this order and validates the transaction when this verification is positive. Otherwise, the transaction fails.

Payment validation information can then be sent at E33 to the merchant server SM which receives it at E26 to then deliver the order of the user.

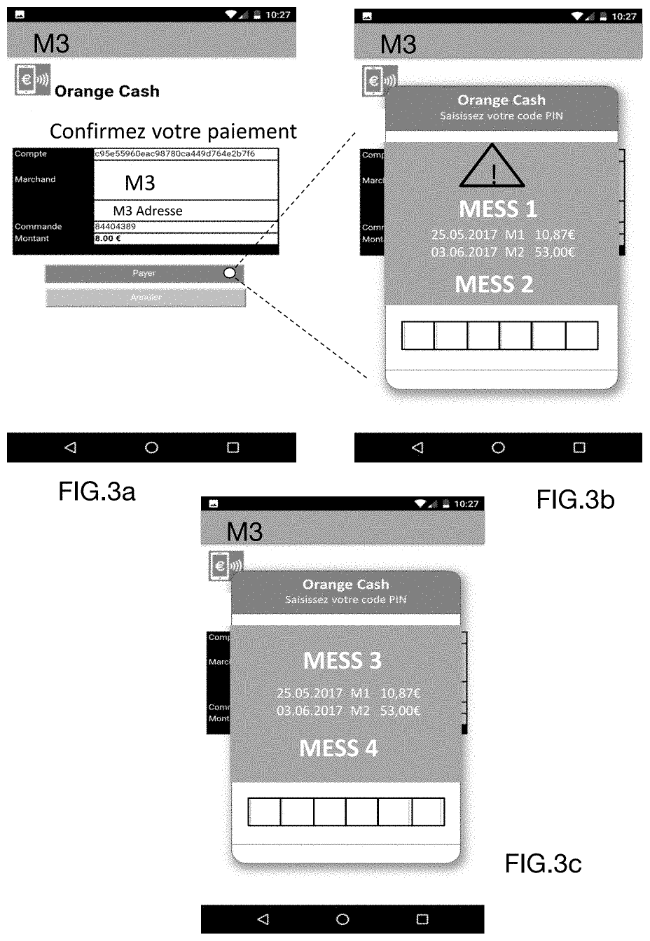

An example of payment interface received on the terminal TA is illustrated in FIGS. 3a to 3c. FIG. 3a shows the payment interface with an “Orange Cash” payment server, displayed on the terminal of a user who has made an order with the merchant M3 whose address is displayed. The order number is also displayed as well as the associated amount. The account of the user which will make it possible to perform the payment is also displayed. To perform the payment, the user actuates the “pay” button on this interface. If or she cancels this order, he or she actuates the “cancel” button.

The action on the “pay” button makes it possible to trigger the method for checking the validity of the payment interface on the terminal as well as the implementation of the corresponding method for sending validation data on the payment server.

The payment server consults its database to reach the latest data on transactions that the user has had with this payment site.

These data are sent to the terminal which displays them according to an example illustrated in FIG. 3b.

It can be seen in fact that the last two transactions are displayed, a first having been performed on 25 May 2017 with the merchant M1 for an amount of 10.87€ and the second having been performed on 3 Jun. 2017 with the merchant M2 for an amount of 53€.

These data can be accompanied by a first explanatory message (MESS 1) of the type of “Verify that you can validate the information below before validating the payment”.

A cautioning message can also be displayed (MESS 2) of the type of “If this information is not yours or does not correspond to you, DO NOT ENTER YOUR PIN CODE”.

Inputting of the PIN code concerned can then be done in the squares provided for this purpose on the interface.

With this interface it is for the user himself or herself to perform the verification of the historical data. He or she must recall the latest data on transactions that he or she has performed with this payment site to enter his or her PIN code and thus validate the payment.

In another embodiment in which the verification of the validity of the historical data sent is performed automatically by the terminal, the payment interface can be a little different, as illustrated in FIG. 3c. Here, a message MESS 3 can inform that the terminal has indeed performed its verification. This message can be of the type of “The historical data of the latest transactions received and displayed below have indeed been validated”.

And a message “MESS 4” can confirm that the user can enter his or her PIN code in complete confidence. This message can be of the type of “The payment site is valid, you can enter your PIN code in complete confidence”.

The historical data may not be displayed in this embodiment since it is the terminal which performs the verification with the data that it has in memory. In this case, the message MESS 3 does not include the words “and displayed below”.

If the data are also displayed, as illustrated in FIG. 3c, then a double verification can be performed, by the terminal and by the user before he she enters the requested PIN code.

In a variant embodiment, the visual interfaces thus represented can be transformed into voice interfaces. The historical data received are thus spoken as are the messages accompanying them. Likewise, the payment interface can be a voice interface in which the user is asked to vocally enter his or her payment validation code after he or she has verified the historical data.

Likewise, these interfaces can be composed of a vocal part, for example the historical data received, and rendered vocally, and of a visual part, for example the payment interface, the entry of the validation code by the user being then performed through a touch keypad and not determined.

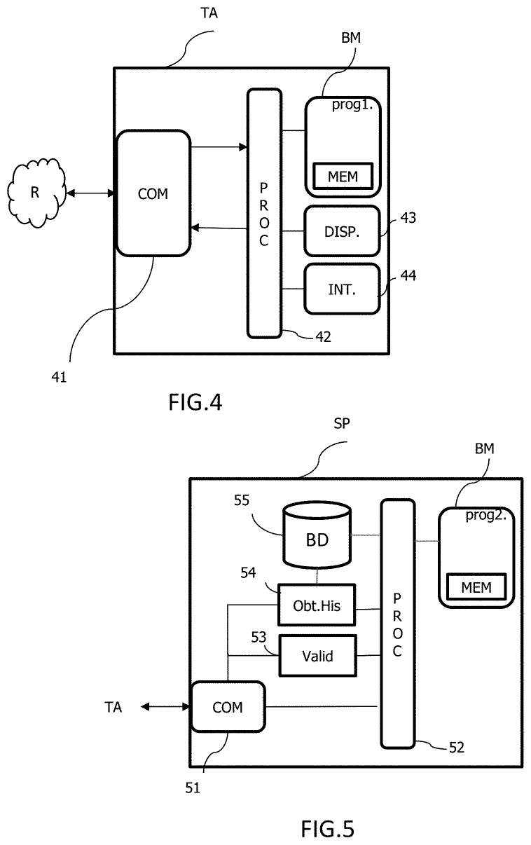

FIG. 4 now illustrates a hardware representation of a device for checking the validity of a remote payment interface TA according to an embodiment of the invention. This device can be incorporated in a communication terminal, for example a mobile communication terminal, of “smartphone”, computer, tablet, connected object or other equivalent type.

This device implements the method for checking the validity of a payment interface described with reference to FIG. 2 by the main steps E20 to E23.

Materially, this device TA comprises a processing circuit 42 comprising a processor and cooperating with a memory block BM comprising a storage and/or working memory MEM.

The processor drives the processing modules capable of implementing the validity checking method described with reference to FIG. 2.

The term module can correspond both to a software component and to a hardware component or a set of hardware and software components, a software component itself corresponding to one or more computer programs or subprograms or, more generally, to any element of a program capable of implementing a function or a set of functions as described for the modules concerned. Likewise, a hardware component corresponds to any element of a hardware assembly capable of implementing a function or a set of functions for the module concerned (integrated circuit, chipcard, memory card, etc.).

The memory block can advantageously comprise a computer program (prog1.) comprising code instructions for implementing the steps of the method for checking the validity of a remote payment interface within the meaning of the invention, when these instructions are executed by the processor PROC and notably, during a payment transaction between a user and a remote payment site, the steps of reception of at least one historical datum of a transaction between the user and the payment site and the sending of a transaction validation code as a function of the at least one historical datum.

This program can use any programming language, and be in the form of source code, object code, or intermediate code between source code and object code, such as in a partially-compiled form, or in any other desirable form.

On initialization, the instructions of the computer program (prog.1) are for example loaded into RAM (Random Access Memory) before being executed by the processor of the processing unit 42. The processor of the processing unit 42 implements the steps of the checking method as described according to the instructions of the computer program.

Typically, the description of FIG. 2 goes over the steps of an algorithm of such a computer program. The computer program can also be stored on a memory medium that can be read by a reader of the device or that can be downloaded into the memory space thereof.

The memory MEM stores generally, all the data necessary to the implementation of the checking method and, notably, in one embodiment of the checking method, data concerning the past latest transactions in correlation with the payment sites concerned.

The device also has a screen 43 capable of displaying the command interfaces and the payment transaction interfaces. The screen is thus capable of displaying a historical transaction data received from a payment server and of simultaneously displaying a payment validation code input request.

Examples of such interfaces are illustrated with reference to FIGS. 3a to 3c.

The device also comprises a user interface 44 (for example a touch interface on the screen or else an interface of physical keyboard type) allowing the user to interact in an order or a payment, for example by entering a payment validation code in the case where the historical transaction data have been verified as valid.

The user interface 44 can also, in one embodiment, be a voice interface which translates the messages received and in particular the historical data received, into voice messages via vocal rendering means of loudspeaker type that are not represented here.

Likewise, this voice interface makes it possible to receive voice messages from the user via means for picking up sound such as microphones that are not represented here.

The device TA also comprises a communication module capable of receiving one or more historical data on transactions between the user and the payment site and of sending a transaction validation code via an interaction with the user interface 44 and the payment interface displayed, in the case where the historical transaction data have been verified as valid.

This communication module 41 is for example a network interface COM (for example a WiFi, 3G, 4G or Ethernet interface), allowing the device to connect to a telecommunication network R and to exchange data with other devices or servers of merchant server or payment server type, via the telecommunication network. This communication module makes it possible in particular to exchange messages with a conversational agent in the case of an implementation by conversational commerce.

FIG. 5 now illustrates a hardware representation of a device SP for sending validation data for a payment site according to an embodiment of the invention. This device can be incorporated in a payment server in a communication network.

This device implements the method for sending validation data for a payment site described with reference to FIG. 2 by the main steps E27 to E33.

It has a communication module 51 making it possible to communicate with other equipment of the communication network, for example with the terminal TA.

The communication module 51 can be, for example, a WiFi, 3G, 4G network interface or even an Ethernet interface and allows the device to transmit messages to the terminal TA or to another server of the network, for example a merchant server SM. It makes it possible to send historical transaction data to the terminal and to send payment interfaces to receive payment validation data in return.

Materially, this device SP comprises a processing circuit 52 comprising a processor and cooperating with a memory block BM comprising a storage and/or working memory MEM.

The processor drives processing modules capable of implementing the method for sending validation data according to the invention. Thus, this device comprises a memory containing historical data on transactions between the user and the payment site. This memory can be in the form of a database 55 internal to the server or else external thereto. The processing module then invoking this database via the communication module 51.

The device or server SP comprises a module 54 for obtaining at least one of these data, driven by the processing circuit and capable of reading, in the database, these historical data stored in correlation with user identifiers.

The communication module 51 is capable of sending, to the terminal TA, historical data obtained and of receiving a transaction validation code from the user of the terminal, the reception of the validation code being conditioned on the verification of validity of the historical data sent.

The device SP comprises a module 53 for validating the payment after verification of the validation code according to authentication data of the user that it has in memory MEM or in the database 55.

The memory block can advantageously comprise a computer program (prog2.) comprising code instructions for implementing the steps of the method for sending validation data for a payment site to a terminal, when these instructions are executed by the processor PROC of the processing module 52 and notably, during a payment transaction between the user of the terminal and the payment site, the steps of obtaining historical data on transactions between the user and the payment site, of sending at least one historical datum obtained to the terminal, of awaiting reception of a transaction validation code from the user of the terminal before validating the payment, the reception of the validation code being conditioned on the verification of validity of the at least one historical datum sent.

This program can use any programming language, and be in the form of source code, object code, or of intermediate code between source code and object code, such as in a partially-compiled form, or in any other desirable form.

On initialization, the instructions of the computer program (prog.2) are for example loaded into RAM (Random Access Memory) before being executed by the processor of the processing unit 52. The processor of the processing unit 52 implements the steps of the method for sending validation data as described according to the instructions of the computer program.

Typically, the description of FIG. 2 goes over the steps of an algorithm of such a computer program. The computer program can also be stored on a memory medium that can be read by a reader of the device or that can be downloaded into the memory space thereof.

The memory MEM generally stores all the data necessary for the implementation of the sending method as described.

Although the present disclosure has been described with reference to one or more examples, workers skilled in the art will recognize that changes may be made in form and detail without departing from the scope of the disclosure and/or the appended claims.

1. A method for checking validity of a remote payment interface, wherein the method comprises the following acts performed on a terminal:
during a payment transaction between a user of the terminal and a remote payment site:
receiving of at least one historical datum of transaction between the user and the payment site; and
sending a transaction validation code as a function of the at least one historical datum.

2. The method as claimed in claim 1, wherein the at least one historical datum received is displayed on the payment interface comprising a validation code request.

3. The method as claimed in claim 2, wherein the display of the at least one historical datum is associated with a display of information cautioning the user if the at least one historical datum is not valid.

4. The method as claimed in claim 1, comprising rendering the at least one historical datum vocally to the user via a voice interface of the terminal.

5. The method as claimed in claim 1, wherein the at least one historical datum comprises data on a date and a amount of a last transaction or of several latest transactions.

6. The method as claimed in claim 1, wherein a transaction datum is a delivery address of the user.

7. The method as claimed claim 1, comprising comparing transaction data stored in the terminal and displaying a message of validation of a valid historical datum verification on the payment interface.

8. The method as claimed in claim 1, further comprising verifying that the at least one historical datum is valid, performed by the user by viewing displayed historical data or by listening to rendered historical data, before interaction with the payment interface to enter transaction validation data.

9. A method for sending validation data from a payment site to a terminal, wherein the method comprises the following acts performed by a server of a payment site:
during a payment transaction between a user of the terminal and the payment site:
obtaining historical data of a transaction between the user and the payment site;
sending at least one historical datum obtained to the terminal; and
awaiting reception of a transaction validation code from the user of the terminal before validating the payment, the reception of the validation code being a function of the at least one historical datum sent.

10. The method as claimed in claim 8, wherein the at least one historical datum is sent with a payment interface comprising a transaction validation code request.

11. A device for checking validity of a remote payment interface, wherein the device comprises:
a processing circuit comprising a processor and configured to control:
a module configured to display a payment transaction interface on a display during a payment transaction between a user and a remote payment site;
a communication module configured t receive at least one historical datum of a transaction between the user and the payment site and send a transaction validation code via an interaction with the payment interface, as a function of the at least one historical datum.

12. The device according to claim 11, wherein the device is implemented in a communication terminal.

13. A server of a payment site, wherein the server comprises:
a processing circuit comprising a processor and configured to control, during a payment transaction between a user and the payment site:
a memory comprising historical data of transactions between the user and the payment site and a module configured to obtain at least one of these data;
a communication module configured to send to the terminal the at least one historical datum obtained and receive a transaction validation code from the user of the terminal, the reception of the validation code being a function of the at least one historical datum sent; and
a module configured to validate the payment after verification of the validation code.

14. (canceled)

15. A non-transitory computer-readable storage medium, that can be read by a processor of a terminal, on which is stored a computer program comprising code instructions for executing a method for checking validity of a remote payment interface when the instructions are executed by the processor, wherein the instructions configure the terminal to perform acts comprising:
during a payment transaction between a user of the terminal and a remote payment site;
receiving of at least one historical datum of transaction between the user and the payment site; and
sending a transaction validation code as a function of the at least one historical datum.

16. A non-transitory computer-readable storage medium, that can be read by a processor of a server for a payment site, on which is stored a computer program comprising code instructions for executing a method for sending validation data from a payment site to a terminal when the instructions are executed by the processor, wherein the instructions configure the server to perform acts comprising:
during a payment transaction between a user of the terminal and the payment site:
obtaining historical data of a transaction between the user and the payment site;
sending at least one historical datum obtained to the terminal; and
awaiting reception of a transaction validation code from the user of the terminal before validating the payment, the reception of the validation code being a function of the at least one historical datum sent
